(19) United States
(12) Patent Application Publication
(10) Pub. No.: US 2026/0191148 A1
(43) Pub. Date: Jul. 9, 2026

(54) LED PLANTING UNIT AND PLANTING DEVICE THEREOF

(71) Applicant: Grow Pros Solutions, Chino, CA (US)

(72) Inventors: Zhihui LONG, Chino, CA (US); Duo ZHANG, Chino, CA (US); Zhiqing ZHU, Chino, CA (US)

(73) Assignee: Grow Pros Solutions, Chino, CA (US)

(21) Appl. No.: 19/415,947

(22) Filed: Dec. 11, 2025

Related U.S. Application Data
(63) Continuation-in-part of application No. 19/012,810, filed on Jan. 7, 2025, now Pat. No. 12,520,774.

(30) Foreign Application Priority Data
Oct. 29, 2025 (CN) 202511561925.8

(51) Int. Cl. A01G 7/04; F21V 33/00; F21Y 113/00; F21Y 115/10

(52) U.S. Cl. CPC A01G 7/045; F21V 33/0088; F21Y 2113/00; F21Y 2115/10

(57) ABSTRACT

The present disclosure relates to the field of plant planting technologies and provides an LED planting unit and a planting device. The LED planting unit includes an LED module with a substrate and a plurality of light beads, and an air duct including a first air duct and a second air duct fixed to each other to form a hollow air passageway. The first air duct includes at least one row of air outlets along a length direction thereof, and each row of air outlets includes a plurality of air outlets, the LED module installed on an outer surface of the first air duct and arranged along the length direction of the first air duct, the substrate in contact with the first air duct. Both the air duct and the substrate are flexibility.

### CROSS-REFERENCE TO RELATED APPLICATION

This application is a continuation-in-part of US Patent Application No. US 19/012810 entitled “LED PLANTING UNIT AND PLANTING DEVICE THEREOF” and filed on January 7, 2025. This application claims priority to China Application No. 202511561925.8, filed on October 29, 2025. The content of which is hereby incorporated by reference in its entire by reference.

### BACKGROUND

### Technical Field

The present disclosure generally relates to the field of plant planting technologies, and especially relates to an LED planting unit and a planting device thereof.

### Description of Related Art

Plants require light and carbon dioxide for photosynthesis during cultivation in order to grow. A growth rate and health of the plants are also related to a surrounding environmental temperature thereof.

At present, for indoor planting, a conventional technology is to provide lighting through LED planting lamps. The LED planting lamp is arranged above the plant for facing the plant, or arranged at the root of the plant for facing the crown of the plant. A concentration of carbon dioxide in the environment is mainly maintained through a ventilation device to keep the environment around the plant to be ventilated, for example, installing a second opening of a fan that is connected to blow air on a planting bracket or above the plant.

However, the above conventional technology has many technical problems, for example:

firstly, when the plant is growing vigorously, the fan cannot fully achieve a circulation of air near the plant. For example, if the second opening is arranged on the planting bracket and the air circulation of the plant on the other side that is away from the second opening is reduced;

secondly, a large volume of the LED planting lamp makes storage inconvenient.

### SUMMARY

The technical problems to be solved: in view of the shortcomings of the related art, the present disclosure provides an LED planting unit and an planting device thereof which can solves the technical problem that a low air flow and an inconvenient storage of plants are occurred in the related art.

In order to solve the above objectives, an LED planting unit according to an embodiment of the present disclosure includes:

an LED module including a flexible substrate and a plurality of light beads mounted on the substrate;

an air duct including a first air duct and a second air duct fixed to each other to form a hollow air passageway thereof, at least one row of air outlets arranged along a length direction of the first air duct, and each row of air outlets comprising a plurality of air outlets arranged at equal intervals and connected to the hollow air passageway;

the LED module installed on an outer surface of the first air duct and arranged along the length direction of the first air duct, the substrate in contact with the first air duct; and wherein

both the air duct and the substrate are flexibility, when air blows into the air duct, the air duct is filled and unfolded along the length direction thereof, and the LED module is unfolded along with the air duct, and when there is no air or a small amount of air in the air duct, the air duct becomes soft and is rolled together with the LED module.

Wherein the air duct is made of plastic film or flexible fiber fabric, and both the first air duct and the second air duct are made of light shading reflective film, transparent film, white film, or black film.

Wherein the LED planting unit further includes a transparent cover arranged along the length direction of the air duct and connected to the first air duct, the LED module arranged inside the transparent cover, wherein the transparent cover is flexibility.

Wherein the transparent cover is a transparent film and provided to install the LED module on a top of the first air duct through a hot-pressing way.

Wherein the first air duct and the second air duct are fixed to each other by a hot-pressing way or an adhesive way.

An LED planting unit according to another embodiment of the present disclosure includes:

an LED module including a flexible substrate and a plurality of light beads mounted on the substrate;

an air duct including a first air duct and a second air duct fixed to each other to form a hollow air passageway thereof, at least one row of air outlets arranged along a length direction of the first air duct, and each row of air outlets comprising a plurality of air outlets arranged at equal intervals and connected to the hollow air passageway;

the LED module installed on an inner surface of the second air duct and arranged along a length direction of the second air duct, the substrate in contact with the second air duct; and wherein

both the air duct and the substrate are flexibility, when air blows into the air duct, the air duct is filled and unfolded along the length direction thereof, and the LED module is unfolded along with the air duct, and when there is no air or a small amount of air in the air duct, the air duct becomes soft and is rolled together with the LED module.

Wherein the air duct is made of plastic film, the first air duct is made of transparent film and configured to emit light, and the second air duct is made of light shading reflective film.

Wherein the LED planting unit further comprises a transparent cover arranged along the length direction of the air duct and connected to the second air duct, the LED module arranged inside the transparent cover, wherein the transparent cover is flexibility.

Wherein the transparent cover is a transparent film and provided to install the LED module on the interior of the second air duct through a hot-pressing way or an adhesive way.

Wherein the first air duct and the second air duct are fixed to each other by a hot-pressing way or an adhesive way.

A planting device according to another embodiment of the present disclosure includes:

at least one fan and at least one LED planting unit, wherein the at least one fan is configured to supply air to the at least one LED planting unit; and wherein

the at least one LED planting unit includes:

at least one LED module including a flexible substrate and a plurality of light beads mounted on the substrate;

at least one air duct with a hollow air passageway thereof, wherein the at least one air duct is provided with at least one row of air outlets connected to the air passageway, and each row of air outlets comprises a plurality of air outlets arranged at equal intervals; and wherein

the LED module is installed on the air duct and arranged along a length direction of the air duct; and wherein

both the air duct and the substrate are flexibility, when air blows into the air duct, the air duct is filled and unfolded along the length direction thereof, and the LED module is unfolded along with the air duct, and when there is no air or a small amount of air in the air duct, the air duct becomes soft and is rolled together with the LED module.

Wherein the air duct includes a first air duct and a second air duct fixed to each other to form the passageway thereof.

Wherein the LED module is connected to an outer surface of the first air duct, and a light output direction of the LED module is towards a side away from the first air duct.

Wherein the air duct is made of plastic film, and both the first air duct and the second air duct are made of light shading reflective film, transparent film, white film, or black film.

Wherein the LED planting unit further includes a transparent cover, and a receiving room is formed between the outer surface of the first air duct and the transparent cover, and configured to receive the LED module therein.

Wherein the LED module is connected to an inner surface of the second air duct, and the light output direction is towards the first air duct.

Wherein the air duct is made of plastic film, the first air duct is made of transparent film and configured to emit light, and the second air duct is made of light shading reflective film.

Wherein the first air duct and the second air duct are fixed to each other by a hot-pressing way or an adhesive way.

Wherein when the at least one LED planting unit comprises two or more LED planting units, adjacent two LED planting units are connected at the beginning and end through a connecting structure, and the fan is connected to a first LED planting unit of the two or more LED planting units.

Wherein the fan and an end of the air duct are fixedly connected to each other through a drawstring elastic rope, and the connecting structure is selected from one of a snap fastener, a magnet, a zipper and a Velcro.

In the present disclosure, the fan blows air into the air passageway, and the flowing air flows out through the air outlets, which can evenly circulate the surrounding air. The flexible air duct and the flexible substrate are provided, so that when there is no or a small amount of air in the air duct, the air duct and the substrate can be rolled together for being convenient storage.

### BRIEF DESCRIPTION OF THE DRAWINGS

FIG. 1 is a schematic view of an LED planting unit in accordance with an embodiment of the present disclosure.

FIG. 2 is a schematic view of the LED planting unit of FIG. 1, shown the LED planting unit in a filling state.

FIG. 3 is a schematic view of an LED planting unit in accordance with another embodiment of the present disclosure, shown the LED planting unit in a semi-filling state.

FIG. 4 is similar to FIG. 3, shown the LED planting unit in a filling state.

FIG. 5 is a schematic view of a planting device in accordance with an embodiment of the present disclosure, which is shown that a connecting structure between two ends of the air duct of the planting device is a snap fastener.

FIG. 6 is a schematic view of a connecting structure between two ends of the air duct of the planting device, which is a zipper.

FIG. 7 is a schematic view of a connecting structure between two ends of the air duct of the planting device, which is a magnet.

FIG. 8 is a schematic view of a connecting structure between two ends of the air duct of the planting device, which is a Velcro.

The element labels according to the embodiment of the present disclosure shown as below:

100, 100’ LED planting unit, 10, 10’ LED module, 11, 11’ substrate, 12, 12’ light bead, 20, 20’ air duct, 21, 21’ first air duct, 211, 211’ outer surface, 212, 212’ air outlet, 22, 22’ second air duct, 23, 23’ air passageway, 30, 30’ transparent cover, 31 receiving room, 200 fan.

### DETAILED DESCRIPTION

Reference will now be made in detail to embodiments, examples of which are illustrated in the accompanying drawings.

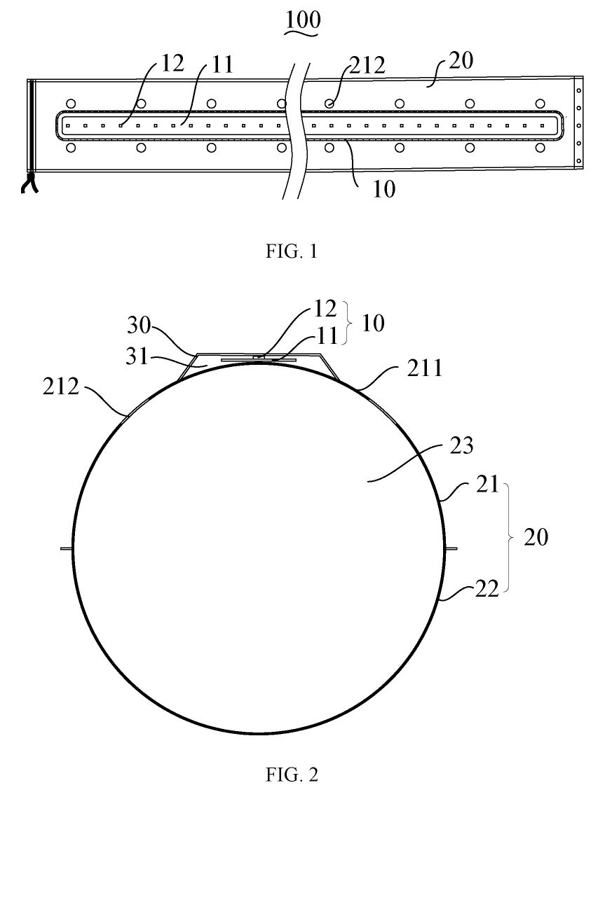

Referring to FIGS. 1-2, an LED planting unit according to an embodiment of the present disclosure includes an LED planting unit 10 and an air duct 20.

The LED module 10 includes a flexible substrate 11 and a plurality of light beads 12 mounted on the substrate 11.

The air duct 20 includes a first air duct 21 and a second air duct 22 fixed to each other to form a hollow air passageway 23 thereof, at least one row of air outlets 212 arranged on an outer surface 211 of the first air duct 21 along the length direction of the first air duct 21, and each row of air outlets 212 including a plurality of air outlets 212 arranged at equal intervals and connected to the hollow air passageway 23.

The LED module 10 is installed on the outer surface 212 of the first air duct 21 and arranged along the length direction of the first air duct 21, the substrate 11 in contact with the first air duct 21; and wherein both the air duct 20 and the substrate 11 are flexibility.

When air blows into the air duct 20, the air duct 20 is filled and unfolded along the length direction thereof, and the LED module 10 is unfolded along with the air duct 20, and when there is no air or a small amount of air in the air duct 20, the air duct 20 becomes soft and is rolled together with the LED module 10.

Specifically, in an embodiment of the present disclosure, the LED module 10 includes the flexible substrate 11, on which the plurality of light beads 12 are mounted. The air duct 20 is composed of the first air duct 21 and the second air duct 22, which are fixed together and form the hollow air passageway 23. The outer surface 211 of the first air duct 21 along the length direction is provided with the at least one row of air outlets 212, each row of air outlets 212 including the plurality of air outlets 212. Meanwhile, the air duct 20 as a whole has flexibility. The LED module 10 is installed on the outer surface 211 of the first air duct 21 and is arranged along the length direction of the first air duct 21, with the substrate 11 in contact with the first air duct 21.

In an embodiment of the present disclosure, the flexible air duct 20 and the flexible substrate 11 complement each other, for providing a basic condition for the morphological changes of the entire LED planting unit 100, thereby enabling the LED planting unit 100 to switch between an unfolded state and a curled state. The LED module 10 is installed along the length direction of the first air duct 21 and the substrate 11 is in contact with the first air duct 21, for forming a tight structural relationship between the LED module 10 and the air duct 20, so that it can ensure that the LED module 10 can move synchronously when the air duct 20 is unfolded or curled. The air outlet 212 of the first air duct 21 is connected to the hollow air passageway 23. The air passageway 23 is configured to provide an air source for the air outlet 212, while the air outlet 212 is the outlet for the air output in the air passageway 23, which are to form an air delivery system.

When air blows into the air duct 20, due to the flexibility of the air duct 20, the air duct 20 is filled and unfolded along the length direction thereof. Due to a tight connection between the LED module 10 and the air duct 20 and the flexibility of the substrate 11, the LED module 10 will unfold together with the air duct 20. At this time, the plurality of light beads 12 can emit light normally to provide illumination for the plants. The air outlet 212 of the first air duct 21 can evenly output air to supplement carbon dioxide for the plants, meet needs of photosynthesis, which can improve the problem of uneven air circulation in the related art. When there is no air or only a small amount of air in the air duct 20, the air duct 20 becomes soft due to its flexibility. Combined with the flexibility of the substrate 11, the entire unit can be rolled into one piece, thereby significantly reducing a total volume thereof and solving the problems of a large volume and inconvenient storage of the conventional LED planting lamp, so that the LED planting unit is easier to be managed and stored.

It should be noted that both the first air duct 21 and the second air duct 22 are long strips with a semi-circular cross-section thereof. The first air duct 21 and the second air duct 22 are connected to each other to form the hollow air passageway 23, and are fixed together by hot-pressing and sewing or bonding at connection positions between the first air duct 21 and the second air duct 22.

Furthermore, the air duct 20 is made of plastic film or flexible fiber fabric, and both the first air duct 21 and the second air duct 22 are made of light shading reflective film, transparent film, white film, or black film.

Specifically, the entire air duct 20 is made of a plastic film material, with both the first air duct 21 and the second air duct 22 are made of light shading reflective film. The plastic film has good flexibility and can meet needs that the air duct 20 can be easily expanded and curled. The light shading reflective film combines characteristics of shading light and reflecting light. The air duct 20 can be made of flexible fiber fabric.

The air duct 20 is made of plastic film material, which not only has a low cost, but also is lightweight, for further reducing an overall weight of the LED planting unit 100, so that the LED planting unit 100 is easy to be installed and moved. At the same time, the plastic film has excellent flexibility, thereby making the unfolding and curling of the air duct 20 more flexible, and extending a service life thereof. The first air duct 21 and the second air duct 22 are made of light shading reflective film. Both the first air duct 21 and the second air duct 22 can reflect the light emitted from the LED module 10, which can improve a utilization rate of the light, enhance an illumination effect for the plants, and promote plant photosynthesis thereof.

It should be noted that both the first air duct 21 and the second air duct 22 can also be made of transparent film, white film, or black film.

Furthermore, the LED planting unit 100 further includes a transparent cover 30 arranged along the length direction of the air duct 20 and connected to the first air duct 21, the LED module 10 arranged inside the transparent cover 30.

Specifically, in an embodiment of the present disclosure, the LED planting unit 100 adds the transparent cover 30 arranged on the outer surface 211 of the first air duct 21, which is connected to the first air duct 21 to form a receiving room 31, and is arranged along the length direction of the air duct 20. The LED module 10 is arranged inside the receiving room 31. The translucent cover 30 has translucency, for allowing the light emitted from the LED module 10 to pass therethrough. The transparent cover 30 is connected to the first air duct 21 and is arranged along the length direction of the air duct 20, which allows the transparent cover 30 to extend in the same length direction as the first air duct 21 and the LED module 10 that is installed on the outer surface 211, thereby forming an integrated structure thereof.

Due to the LED module 10 being arranged inside the transparent cover 30, the transparent cover 30 provides a surrounding protection for the LED module 10, and the LED module 10 and the transparent cover 30 are closely related in spatial positions, so that the light emitted from the LED module 10 can be transmitted outward through the transparent cover 30.

The transparent cover 30 also has flexibility, which cooperates with the flexible air duct 20 and the flexible substrate 11. When the air duct 20 is unfolded or curled, the transparent cover 30 can change synchronously with the overall structure without affecting a form switching function of the LED planting unit 100. The transparent cover 30 wraps the LED module 10 inside, for effectively blocking external dust, water vapor and other impurities from contacting the plurality of light beads 12, thereby reducing the damage or decrease in luminous efficiency caused by pollution, extending the service life of the LED module 10, and ensuring the lighting stability thereof.

A transparency of the transparent cover 30 ensures that the light emitted from the LED module 10 can penetrate and shine on the plants normally without affecting the lighting effect. At the same time, the transparent cover 30 can also gather the light to a certain extent, thereby improving the light concentration and enhancing the photosynthesis effect thereof.

When the air duct 20 is curled to be stored, the transparent cover 30 provides additional buffering protection for the internal LED module 10, thereby avoiding damage to the light beads 12 due to compression or collision during the curling process, and further improving the storage safety of the device.

Furthermore, the transparent cover 30 is a transparent film and provided to install the LED module 10 on a top of the first air duct 21 through a hot-pressing way.

Specifically, the transparent cover 30 is a transparent film that the hot-pressing way is used to install the LED module 10 on the top of the first air duct 21, and is arranged along the length direction of the air duct 20, so that the LED module 10 is wrapped inside the transparent film. The transparent film has good transparency, for allowing the light emitted from the LED module 10 to pass through smoothly. The transparent film is connected to the first air duct 21 through the hot-pressing way, which forms a stable overall structure between the transparent film, the LED module 10 and the first air duct 21. Compared with an ordinary connection, it is tighter and can effectively avoid relative displacement thereamong during being used or the form switching.

The transparent film is taken as the translucent cover 30 to wrap around the LED module 10. Due to the hot-pressing installation, the translucent cover 30 has a higher degree of adhesion with the first air duct 21, for providing a tighter surrounding protection for the LED module 10 and further strengthening the spatial connection with the LED module 10, thereby ensuring that light transmission is unobstructed.

The transparent film itself has a certain degree of flexibility and works better with the flexible air duct 20 and the flexible substrate 11. When the air duct 20 is unfolded or curled, it can smoothly synchronize with the overall changes without affecting the form switching function of the LED planting unit 100. Moreover, the stability of the thermal compression connection will not be reduced due to shape changes.

Furthermore, the first air duct 21 and the second air duct 22 are fixed to each other by a hot-pressing way or an adhesive way.

Specifically, the first air duct 21 and the second air duct 22 are fixed together by the hot-pressing way or the adhesive way, which can form a more stable overall structure with the transparent film and the LED module 10 as the air duct 20. Due to the tight connection between the first air duct 21, the transparent film and the LED module 10, the stable connection of the air duct 20 further enhances structural integrity of the entire planting unit.

The first air duct 21 and the second air duct 22 that are fixed together by the hot-pressing way or the adhesive way to form the more stable hollow air passageway 23, which can be filled more evenly during blowing air, for ensuring that the air duct 20 is smoothly unfolded along the length direction, thereby driving the LED module 10 and the transparent film to be synchronously and stably unfolded. When there is no air and the LED planting unit 100 is curled, the integrated air duct 20 can also be rolled more neatly with other components, thereby reducing a situation of loose structures.

The first air duct 21 and the second air duct 22 are fixed together by the hot-pressing way or the adhesive way, thereby greatly improving the structural strength and sealing effect of the air duct 20, avoiding air leakage problems caused by weak connections, ensuring effective air transportation in the air passageway 23, enabling a stable output of air from the air outlet 212 of the first air duct 21, and providing continuous and stable carbon dioxide supply for the plant. The integral air duct 20 is less likely to be damaged during the unfolding and curling process, for extending the service life of the air duct 20, thereby enhancing the durability of the entire LED planting unit 100. At the same time, the stable connection reduces shaking and noises to be occurred in the air duct 20 during being used, thereby improving stability and quietness of equipment operation.

The hot-pressing fixation process is easy to be operated and suitable for mass production, which is conducive to reducing a manufacturing cost of the LED planting unit 100, improving production efficiency, and providing convenience for a large-scale application thereof.

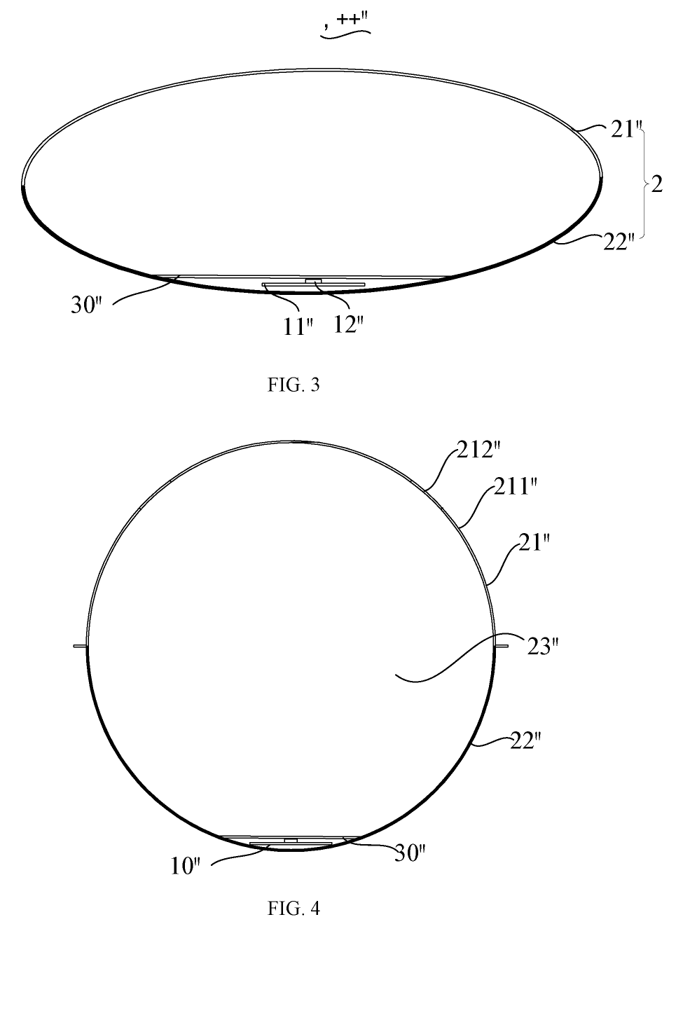

Referring to FIG. 3 and FIG. 4, an LED planting unit 100’ in accordance with another embodiment of the present disclosure is provided. The LED planting unit 100’ includes an LED module 10’ and an air duct 20’. The LED module 10’ includes a flexible substrate 11’ and a plurality of light beads 12’ mounted on the substrate 11’. The air duct 20’ includes a first air duct 21’ and a second air duct 22’ fixed to each other to form a hollow air passageway 23’ thereof, at least one row of air outlets 212’ arranged on an outer surface 212’ of the first air duct 21’ along a length direction of the first air duct 21’, and each row of air outlets 212’ has a plurality of air outlets 212’ arranged at equal intervals and connected to the hollow air passageway 23’.

The LED module 10’ is installed on an inner surface of the second air duct 22’ and arranged along a length direction of the second air duct 22’, the substrate 11’ in contact with the second air duct 22’; and wherein both the air duct 20’ and the substrate 11’ are flexibility, when air blows into the air duct 20’, the air duct 20’ is filled and unfolded along the length direction thereof, and the LED module 10’ is unfolded along with the air duct 20’, and when there is no air or a small amount of air in the air duct 20’, the air duct 20’ becomes soft and is rolled together with the LED module 10’.

Specifically, in an embodiment of the present disclosure, the LED module 10’ includes the flexible substrate 11’, on which the plurality of light beads 12’ are mounted. The substrate 11’ has flexibility and can adapt to morphological changes. The air duct 20’ is composed of the first air duct 21’ and the second air duct 22’, which are fixed together and form the hollow air passageway 23’. The outer surface 211’ of the first air duct 21’ along the length direction is provided with the at least one row of air outlets 212’, each row of air outlets 212’ including the plurality of air outlets 212’. Meanwhile, the air duct 20’ as a whole has flexibility. The LED module 10’ is installed on the inner surface of the first air duct 21’ and is arranged along the length direction of the second air duct 22’, with the substrate 11’ in contact with the second air duct 22’.

The flexible air duct 20 and the flexible substrate 11 complement each other, for providing a basic for the morphological changes (unfolding and curling) of the LED planting unit 100’, and ensuring that the flexible air duct 20 and the flexible substrate 11 can move synchronously. The LED module 10’ is installed along the length direction of the second air duct 22’ and the substrate 11’ is in contact with the second air duct 22’, for forming a tight structural relationship between the LED module 10’ and the air duct 20’, so that it can ensure that the LED module 10’ can move synchronously when the air duct 20’ is unfolded or curled.

The air outlet 212’ of the first air duct 21’ is connected to the hollow air passageway 23’. The air passageway 23’ is configured to provide an air source for the air outlet 212’, while the air outlet 212’ is the outlet for the air output, which are to form an air delivery system. The first air duct 21’ and the second air duct 22’ are fixed as a whole, for forming an overall structure that provides a stable carrier for the installation and air delivery of the LED module 10’.

When air blows into the air duct 20’, due to the flexibility of the air duct 20’, the air duct 20’ is filled and unfolded along the length direction thereof. Due to a tight connection between the LED module 10’ and the air duct 20’ and the flexibility of the substrate 11’, the LED module 10’ will unfold together with the air duct 20’. At this time, the plurality of light beads 12’ can emit light normally to provide illumination for the plants. The air outlet 212’ of the first air duct 21’ can uniformly outputs air to supplement carbon dioxide, thereby meeting needs of plant photosynthesis and solving the problem of uneven air circulation. When there is no air or only a small amount of air in the air duct 20’, the air duct 20’ becomes soft due to its flexibility. Combined with the flexibility of the substrate 11’, the entire unit can be rolled into one piece, thereby significantly reducing a total volume thereof and solving the problems of inconvenient storage of the conventional LED planting lamp, so that the LED planting unit 100’ is easier to be managed and stored.

The LED module 10’ is installed on the inner surface of the second air duct 22’, which can reduce direct impact of external environment to the light beads 12’, protect the light beads 12’ to a certain extent, extend the service life of the light beads 12’, and not affect the light to normally illuminate the plants.

Furthermore, the air duct 20’ is made of plastic film, the first air duct 21’ is made of transparent film and configured to emit light, and the second air duct 22’ is made of light shading reflective film. A light output direction of the LED module 10’ is directed towards the first air duct 21’ and illuminates the outside of the first air duct 21’.

In an embodiment of the present disclosure, the air duct 20’ is made of plastic film material, and the first air duct 21’ is made of transparent film with the light emission function. The second air duct 22’ is a light shading reflective film that can block the light and reflect the light. The first air duct 21’ is made of transparent film and can emit light, which is compatible with the light output direction of the LED module 10’ facing the first air duct 21’, so that the light emitted from the LED module 10’ can smoothly pass through the first air duct 21’ and light on the external plants, thereby forming an efficient light transmission path thereof. The second air duct 22’ is the light shading reflective film that works in conjunction with the LED module 10’ that emits the light towards the first air duct 21’, which can reflect the light that may leak towards the second air duct 22’ back to the first air duct 21’, for reducing light loss and improving light utilization efficiency, which can complement the light transmission and output function of the first air duct 21’.

Furthermore, the LED planting unit 100’ further includes a transparent cover 30’ arranged along the length direction of the air duct 20’ and connected to the second air duct 22’, the LED module 10’ arranged inside the transparent cover 30’. The transparent cover 30’ is a transparent film and provided to install the LED module 10’ on the interior of the second air duct 22’ through a hot-pressing way.

In an embodiment of the present disclosure, the transparent cover 30’ is made of transparent film and connected to the second air duct 22’. The transparent cover 30’ is arranged along the length direction of the air duct 20’ and is compatible with the first air duct 21’ and the second air duct 22’, which are also made of plastic film material, in terms of materials and setting direction, so that the overall structure is more coordinated. The transparent cover 30’ is provided to install the LED module 10’ onto the second air duct 22’ through the hot-pressing way, for enhancing the connection stability between the LED module 10’ and the second air duct 22’. At the same time, the LED module 10’ is arranged inside the transparent cover 30’, so that a tight wrapping and being wrapped relationship are formed among the transparent cover 30’, the LED module 10’ and the second air duct 22’, thereby ensuring that the light can sequentially pass through the transparent cover 30’ and the second air duct 22’ to shine outwardly. The transparent film characteristics of the transparent cover 30’ are matched with that of the second air duct 22’, which will not obstruct the light transmission of the LED module 10’, but are together to form a dual light transmission guarantee, for further ensuring that the light can be output efficiently.

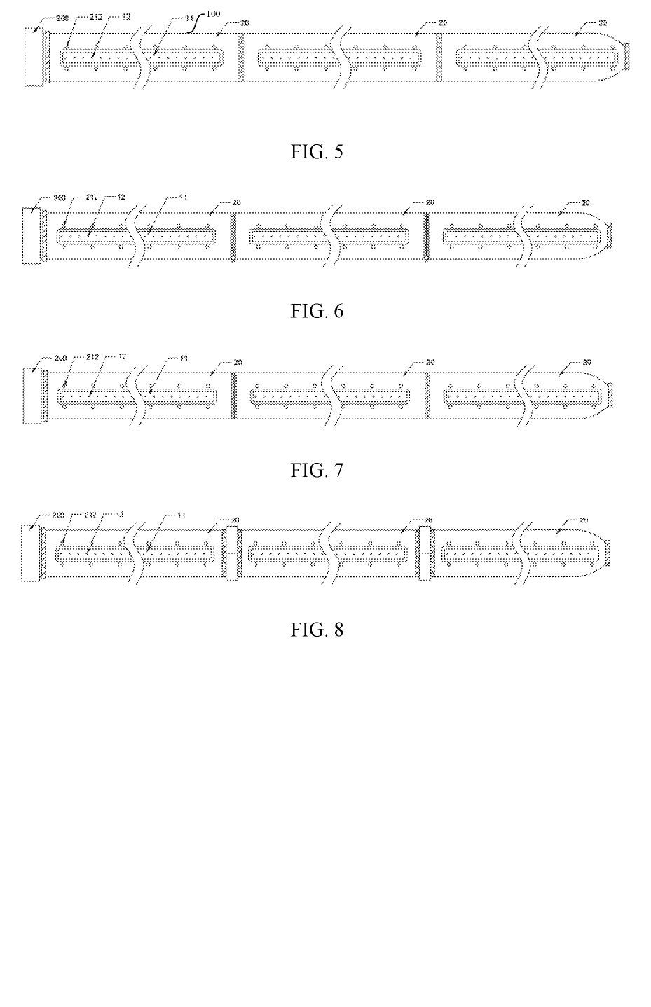

Referring to FIGS. 1-2 and FIG. 5, a planting device in accordance with an embodiment of the present disclosure is provided and includes a fan 200 and at least one LED planting unit 100, wherein the fan is configured to supply air to the LED planting unit 100.

The LED planting unit 100 includes an LED module 10 and at least one air duct 20, the LED module 10 including a flexible substrate 11 and a plurality of light beads 12 mounted on the substrate 11. The air duct 20 has a hollow air passageway 23, and at least one row of air outlets 212 that is connected to the air passageway 23 is provided on the air duct 20. Each row of air outlets 212 includes a plurality of air outlets 212. The LED module 10 is installed on the air duct 20 and arranged along a length direction of the air duct 20. Both the air duct 20 and the substrate 11 are flexibility, when air blows into the air duct 20, the air duct 20 is filled and unfolded along the length direction thereof, and the LED module 10 is unfolded along with the air duct 20, and when there is no air or a small amount of air in the air duct 20, the air duct 20 becomes soft and is rolled together with the LED module 10. The air duct 20 includes a first air duct 21 and a second air duct 22 fixed to each other to form the passageway 23 thereof. The LED planting unit 100 further includes a transparent cover 30, and a receiving room is formed between an outer surface 212 of the first air duct 21 and the transparent cover 30, and configured to receive the LED module 10 therein. The first air duct 21 and the second air duct 22 are fixed to each other by a hot-pressing way.

When there are two or more LED planting units 100, adjacent two LED planting units 100 are connected end-to-end so that the air duct 23 of each LED planting unit 100 is connected, and the fan 200 is connected to a first LED planting unit 100. Only one fan 200 can blow air to all LED planting units 100. An end of the air duct 20 is equipped with a drawstring elastic rope, so that the fan 200 is connected with the air duct 20 through the drawstring elastic rope to blow air inside the air duct 20. Specifically, the end of the air duct 20 with the drawstring elastic rope is sleeved on the outside of the fan 200, so that the fan 200 is connected to the end of the air duct 20 by tightening the drawstring elastic rope.

Referring to FIG. 6, FIG. 7 and FIG. 8, two ends of the air duct 20 can also be equipped with snap fasteners, magnets, zippers or Velcro to connect the air duct 20 in sequence, thereby ensuring that only one fan 200 can supplement carbon dioxide for the plurality of air ducts 20. It should be noted that the fan 200 has a sufficient wind power or has an ability to increase the wind power, an insufficient air tightness of the connecting structures such as the snap fasteners, magnets, zippers or Velcro can be ignored in cases of a high wind power thereof.

In an embodiment of the present disclosure, the LED module 10 is connected to the outer surface 211 of the first air duct 21, and the light output direction is towards a side that is away from the first air duct 21. The air duct 20 is made of plastic film or flexible fiber fabric, and both the first air duct 21 and the second air duct 22 are made of light shading reflective film, transparent film, white film, or black film.

In another embodiment of the present disclosure, the LED module 10 is connected to an inner surface of the second air duct 22, and the light output direction is towards the first air duct 21. The air duct 20 is made of plastic film, the first air duct 21 is made of transparent film and configured to emit light, and the second air duct 22 is made of light shading reflective film.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

What is claimed is:

1. An LED planting unit comprising:
an LED module comprising a flexible substrate and a plurality of light beads mounted on the substrate;
an air duct comprising a first air duct and a second air duct fixed to each other to form a hollow air passageway thereof, at least one row of air outlets arranged along a length direction of the first air duct, and each row of air outlets comprising a plurality of air outlets arranged at equal intervals and connected to the hollow air passageway;
the LED module installed on an outer surface of the first air duct and arranged along the length direction of the first air duct, the substrate in contact with the first air duct; and wherein
both the air duct and the substrate are flexibility, when air blows into the air duct, the air duct is filled and unfolded along the length direction thereof, and the LED module is unfolded along with the air duct, and when there is no air or a small amount of air in the air duct, the air duct becomes soft and is rolled together with the LED module.

2. The LED planting unit as claimed in claim 1, wherein the air duct is made of plastic film or flexible fiber fabric, and both the first air duct and the second air duct are made of light shading reflective film, transparent film, white film, or black film.

3. The LED planting unit as claimed in claim 1, wherein the LED planting unit further comprises a transparent cover arranged along the length direction of the air duct and connected to the first air duct, the LED module arranged inside the transparent cover, wherein the transparent cover is flexibility.

4. The LED planting unit as claimed in claim 3, wherein the transparent cover is a transparent film and provided to install the LED module on a top of the first air duct through a hot-pressing way.

5. The LED planting unit as claimed in claim 1, wherein the first air duct and the second air duct are fixed to each other by a hot-pressing way or an adhesive way.

6. An LED planting unit comprising:
an LED module comprising a flexible substrate and a plurality of light beads mounted on the substrate;
an air duct comprising a first air duct and a second air duct fixed to each other to form a hollow air passageway thereof, at least one row of air outlets arranged along a length direction of the first air duct, and each row of air outlets comprising a plurality of air outlets arranged at equal intervals and connected to the hollow air passageway;
the LED module installed on an inner surface of the second air duct and arranged along a length direction of the second air duct, the substrate in contact with the second air duct; and wherein
both the air duct and the substrate are flexibility, when air blows into the air duct, the air duct is filled and unfolded along the length direction thereof, and the LED module is unfolded along with the air duct, and when there is no air or a small amount of air in the air duct, the air duct becomes soft and is rolled together with the LED module.

7. The LED planting unit as claimed in claim 6, wherein the air duct is made of plastic film, the first air duct is made of transparent film and configured to emit light, and the second air duct is made of light shading reflective film.

8. The LED planting unit as claimed in claim 7, wherein the LED planting unit further comprises a transparent cover arranged along the length direction of the air duct and connected to the second air duct, the LED module arranged inside the transparent cover, wherein the transparent cover is flexibility.

9. The LED planting unit as claimed in claim 8, wherein the transparent cover is a transparent film and provided to install the LED module on the interior of the second air duct through a hot-pressing way or an adhesive way.

10. The LED planting unit as claimed in claim 6, wherein the first air duct and the second air duct are fixed to each other by a hot-pressing way or an adhesive way.

11. A planting device comprising:
at least one fan and at least one LED planting unit, wherein the at least one fan is configured to supply air to the at least one LED planting unit; and wherein
the at least one LED planting unit comprises:
at least one LED module comprising a flexible substrate and a plurality of light beads mounted on the substrate;
at least one air duct with a hollow air passageway thereof, wherein the at least one air duct is provided with at least one row of air outlets connected to the air passageway, and each row of air outlets comprises a plurality of air outlets arranged at equal intervals; and wherein
the LED module is installed on the air duct and arranged along a length direction of the air duct; and wherein
both the air duct and the substrate are flexibility, when air blows into the air duct, the air duct is filled and unfolded along the length direction thereof, and the LED module is unfolded along with the air duct, and when there is no air or a small amount of air in the air duct, the air duct becomes soft and is rolled together with the LED module.

12. The planting device as claimed in claim 11, wherein the air duct comprises a first air duct and a second air duct fixed to each other to form the passageway thereof.

13. The planting device as claimed in claim 12, wherein the LED module is connected to an outer surface of the first air duct, and a light output direction of the LED module is towards a side away from the first air duct.

14. The planting device as claimed in claim 13, wherein the air duct is made of plastic film, and both the first air duct and the second air duct are made of light shading reflective film, transparent film, white film, or black film.

15. The planting device as claimed in claim 14, wherein the LED planting unit further comprises a transparent cover, and a receiving room is formed between the outer surface of the first air duct and the transparent cover, and configured to receive the LED module therein.

16. The planting device as claimed in claim 12, wherein the LED module is connected to an inner surface of the second air duct, and the light output direction is towards the first air duct.

17. The planting device as claimed in claim 16, wherein the air duct is made of plastic film, the first air duct is made of transparent film and configured to emit light, and the second air duct is made of light shading reflective film.

18. The planting device as claimed in claim 12, wherein the first air duct and the second air duct are fixed to each other by a hot-pressing way or an adhesive way.

19. The planting device as claimed in claim 12, wherein when the at least one LED planting unit comprises two or more LED planting units, adjacent two LED planting units are connected at the beginning and end through a connecting structure, and the fan is connected to a first LED planting unit of the two or more LED planting units.

20. The planting device as claimed in claim 19, wherein the fan and an end of the air duct are fixedly connected to each other through a drawstring elastic rope, and the connecting structure is selected from one of a snap fastener, a magnet, a zipper and a Velcro.
